(19) United States
(12) Patent Application Publication
(10) Pub. No.: US 2013/0123093 A1
(43) Pub. Date: May 16, 2013

(54) Method for Preparing Impurity-Doped Titanium Dioxide Photocatalysts Representing Superior Photo Activity at Visible Light Region and Ultraviolet Light Region in Mass Production

(71) Applicants: Hae-Jin KIM, Daejeon (KR); Jou-Hahn LEE, Daejeon (KR); Soon-Chang LEE, Daejeon (KR); Hyun-Uk LEE, Chungcheongbuk-do (KR)

(72) Inventors: Hae-Jin KIM, Daejeon (KR); Jou-Hahn LEE, Daejeon (KR); Soon-Chang LEE, Daejeon (KR); Hyun-Uk LEE, Chungcheongbuk-do (KR)

(21) Appl. No.: 13/409,083

(22) Filed: Feb. 29, 2012

(30) Foreign Application Priority Data
Nov. 11, 2011 (KR) 10-2011-0117454

(51) Int. Cl. B01J 21/06; B01J 37/34

(52) U.S. Cl. 502/5

(57) ABSTRACT

A method for preparing impurity-doped titanium dioxide photocatalysts having superior photo activity at a visible light region and an ultraviolet light region in mass production. The titanium dioxide photocatalysts are prepared in mass production using low-price reusable materials at a room temperature when titanium dioxide is doped with carbon, sulfur, nitrogen, fluorine, and phosphorous. The method for preparing impurity-doped titanium dioxide representing superior photo activity in both of the ultraviolet light region and the visible light region in mass production includes: stirring titanium dioxide powder while mixing the titanium dioxide powder with a doping agent; performing ultrasonification with respect to a mixed solution; washing a reactant obtained through the ultrasonification by using a washing solution while performing pressure-reduction filtering with respect to the reactant; obtaining doped titanium dioxide particles by drying the reactant; and performing heat treatment with respect to the doped titanium dioxide particles at a nitrogen atmosphere.

### CROSS-REFERENCE TO RELATED APPLICATION

This application claims the benefit under 35 U.S.A. §119 of Korean Patent Application No. 10-2011-0117454, filed on Nov. 11, 2011 in the Korean Intellectual Property Office, the entirety of which is incorporated herein by reference.

### BACKGROUND OF THE INVENTION

1. Field of the Invention

The present invention relates to a method for preparing impurity-doped titanium dioxide photocatalysts. In more particular, the present invention relates to a method for preparing impurity-doped titanium dioxide photocatalysts, which represent superior photo activity at a visible light region and an ultraviolet light region, in mass production, in which the titanium dioxide photocatalysts can be prepared in mass production at a room temperature by using low-price reusable materials when titanium dioxide is doped with carbon (C), sulfur (S), nitrogen (N), fluorine (F), or phosphorous (P).

2. Description of the Related Art

A titanium dioxide is a photocatalyst that has been extensively utilized due to excellent photo oxidation power, stability, non-toxic property, and low price thereof. The photocatalyst is a material capable of decomposing a variety of recalcitrant organic matters existing in a gas phase or a liquid phase based on the strong oxidizing power generated under the existence of the light.

The photocatalyst is referred to as a material in which the chemical state thereof is changed when a visible light or an ultraviolet light is irradiated onto the surface thereof so that the chemical reaction is accelerated. If a light having bandgap energy exceeding the bandgap energy of the photocatalyst is irradiated onto the photocatalyst, electrons and holes are generated, and strong redox reaction is performed. In the redox process, organic matters are decomposed into harmless carbon dioxide and water.

As a related art, there is Korean Unexamined Patent Publication No. 10-2011-0011973 (published on Feb. 9, 2011). The publication discloses a method for preparing titanium dioxide and a method for manufacturing a dye-sensitized solar cell based on the method for preparing titanium dioxide.

However, there is a disadvantage in that the titanium dioxide having a great bandgap (about 3.2 eV) represents photo activity only for a light source corresponding to an ultraviolet region of about 387 nm or less. Therefore, studies and research have been actively performed to provide a titanium dioxide photocatalyst representing photo activity for a light source of low energy corresponding to a visible light region.

Therefore, in order to maximize the utilization of the sunlight and to apply eco-friendly materials to a daily life, a method for preparing titanium dioxide photocatalysts capable of representing photo sensitivity for the visible light must be developed.

### SUMMARY OF THE INVENTION

An object of the present invention is to provide a method for preparing impurity-doped titanium dioxide photocatalysts representing superior light efficiency and superior photo activity at a visible light region in mass production, by performing a large-scale doping with respect to titanium dioxide photocatalyst materials through post-treatment processes such that the light efficiency and the photo activity can be improved at the visible light region.

Another object of the present invention is to provide a method for preparing titanium dioxide photocatalysts representing superior photo activity in both of the ultraviolet light region and the visible light region in mass production at the low cost by using low-price reusable precursors when impurities are doped into the titanium dioxide at the room temperature.

In order to accomplish the object of the present invention, according to an aspect of the present invention, there is provided a method for preparing impurity-doped titanium dioxide representing superior photo activity in both of the ultraviolet light region and the visible light region. The method includes (a) stirring titanium dioxide powder while mixing the titanium dioxide powder with a doping agent, (b) performing ultrasonification with respect to a mixed solution, (c) washing a reactant obtained through the ultrasonification by using a washing solution while performing pressure-reduction filtering with respect to the reactant, (d) obtaining doped titanium dioxide particles by drying the reactant, and (e) performing heat treatment with respect to the doped titanium dioxide particles at a nitrogen atmosphere.

As described above, the method for preparing impurity-doped titanium dioxide representing superior photo activity in both of the ultraviolet light region and the visible light region has following effects.

First, according to the present invention, the doping agent can include a relatively low price reagent such as distilled water (H₂O), methanol (CH₃OH), sulfuric acid (H₂SO₄), hydrogen peroxide (H₂O₂), methyl ammonium chloride, isopropanol, acetonitrile, fluoroacetic acid, phosphoric acid, ethanol, or hydrochloric acid, thereby preparing titanium dioxide doped with impurities such as C, S, N, F, or P at a low price in mass production.

Second, according to the present invention, impurities can be doped into titanium dioxide powder through simple post-processes such as stirring, ultrasonification, and heat treatment.

Third, according to the present invention, the titanium dioxide doped with impurities (C, S, N, F, or P) represents photo activity in a visible light region as well as an ultraviolet light region, so that the application field of the photocatalyst can be significantly expanded when the titanium dioxide is applied to the surroundings.

Fourth, according to the present invention, a low-price reusable precursor is used at a room temperature when impurities are doped into the titanium dioxide, so that the impurities (C, N, P, F, and S)-doped titanium dioxide photocatalysts not only can represent high crystallinity and a high specific surface area (>400 m²/g), but also can represent a photocatalyst characteristic superior to that of an existing commercial catalyst P25.

Fifth, the existing commercial catalyst P25 represents photo activity only in the ultraviolet light region of 387 nm or less. In contrast, the impurity-doped titanium dioxide photocatalysts can represent superior activity even in the visible light region (>400 nm).

### BRIEF DESCRIPTION OF THE DRAWINGS

FIG. 1 is a process flowchart showing a method for preparing impurity-doped titanium dioxide photocatalyst according to the embodiment of the present invention;

FIG. 2 is a photograph showing a specimen prepared according to embodiment 1;

FIG. 3 is a photograph showing a specimen prepared according to embodiment 2;

FIG. 4 is a graph showing an X-ray diffraction pattern for specimens according to embodiments 1 and 2 and comparative example 1;

FIG. 5 is a graph showing PL (photoluminescence) measurement results for specimens according to embodiments 1 and 2 and comparative examples 1 and 2;

FIG. 6 is a view showing specific surface areas of specimens according to embodiments 1 and 2 and comparative examples 1 and 2; and

FIGS. 7 and 8 are graphs showing organic matter photo-oxidation experimental results related to specimens according to embodiments 1 to 3 and comparative examples 1 and 2.

### DETAILED DESCRIPTION OF THE INVENTION

Advantages and/or characteristics of the present invention, and methods to accomplish them will be apparently comprehended by those skilled in the art when making reference to embodiments in the following description and accompanying drawings. However, the present invention is not limited to the following embodiments, but various modifications may be realized. The present embodiments are provided to make the disclosure of the present invention perfect and to make those skilled in the art perfectly comprehend the scope of the present invention. The present invention is defined only within the scope of claims. The same reference numerals will be used to refer to the same elements throughout the specification.

Hereinafter, a method for preparing impurity-doped titanium dioxide photocatalysts having excellent photo activity at a visible light region and an ultraviolet light region according to an exemplary embodiment of the present invention will be described with reference accompanying drawings.

Method for Preparing Impurity-Doped Titanium Dioxide Photocatalysts

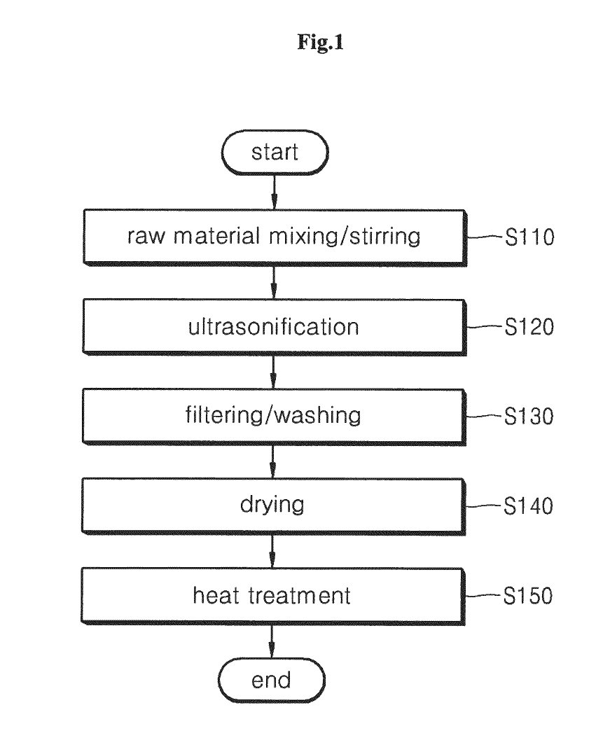

FIG. 1 is a process flowchart showing a method for preparing impurity-doped titanium dioxide photocatalysts according to an embodiment of the present invention.

Referring to FIG. 1, the method for preparing impurity-doped titanium dioxide photocatalysts includes a raw material mixing/stirring step (step S110), an ultrasonification step (step S120), a filtering/washing step (step S130), a drying step (step S140), and a heat treatment step (step S150).

Material Mixing/Stirring Step

In the raw material mixing/stirring step (step S110), titanium dioxide powder is stirred while being mixed with a doping agent. In this case, preferably, the titanium dioxide powder is stirred by a strong mechanical stirrer.

The titanium dioxide powder might be prepared by using one selected from the group consisting of titanium n-butoxide, titanium isopropoxide, and titanium chloride as a titanium precursor.

In this case, the titanium dioxide may include a plurality of nanopores, The nanopores have an average diameter of about 1 nm to about 100 nm, and a specific surface area in the range of about 100 m²/g to about 650 m²/g, but the present invention is not limited thereto.

Meanwhile, the doping agent may include at least one selected from the group consisting of distilled water (H₂O), methanol (CH₃OH), sulfuric acid (H₂SO₄), hydrogen peroxide (H₂O₂), methyl ammonium chloride, isopropanol, acetonitrile, fluoroacetic acid, phosphoric acid, ethanol, and hydrochloric acid.

Among them, preferably, in order to dope the titanium dioxide powder with carbon (C), a mixed solution of the distilled water (H₂O) and the methanol (CH₃OH) is used. In this case, preferably, the mixed solution of the distilled water (H₂O) and the methanol (CH₃OH) representing a volume ratio of 3:1 to 5:1 with respect to the distilled water (H₂O) and the methanol (CH₃OH) is used. When the volume ratio of the distilled water (H₂O) to the methanol (CH₃OH) is 4:1, the best result can be obtained as shown in a PL (Photoluminescence) experimental result. If the content of the methanol (CH₃OH) is increased, doping efficiency may be reduced, and the preparing cost may be increased.

Meanwhile, in order to dope the titanium dioxide powder with sulfur (S), the mixed solution of 2M sulfuric acid (H₂SO₄) and hydrogen peroxide (H₂O₂) is preferably used. In this case, preferably, the volume ratio of the sulfuric acid (H₂SO₄) and hydrogen peroxide (H₂O₂) is 8:1 to 12:1. When the volume ratio of the sulfuric acid (H₂SO₄) and hydrogen peroxide (H₂O₂) is 10:1, the best result can be obtained as shown in the PL experimental result. If the content of the sulfuric acid (H₂SO₄) is increased with respect to the hydrogen peroxide (H₂O₂), the doping efficiency may be reduced, and the preparing cost may be increased.

In order to dope the titanium dioxide powder with nitrogen (N), a mixed solution of methyl ammonium chloride, distilled water (H₂O), isopropanol, and acetonitrile is preferably used. In this case, the volume ratio of methyl ammonium chloride and distilled water is preferably 1:1 to 1:20.

In order to dope the titanium dioxide powder with fluorine (F), a mixed solution of fluoroacetic acid, distilled water (H₂O), and acetonitrile is preferably used. In this case, the volume ratio of fluoroacetic acid and acetonitrile is preferably 1:1 to 1:10. In addition, in order to dope the titanium dioxide powder with phosphors (P), a mixed solution of phosphoric acid, ethanol, and hydrochloric acid is preferably used. In this case, the volume ratio of phosphoric acid and hydrochloric acid is preferably 10:1 to 1:1.

Ultrasonification

In the ultrasonification step (step S120), an ultrasonification is performed with respect to the mixed solution of the titanium dioxide powder and the doping agent. In this case, although the present invention has been described in that the ultrasonification step (step S120) is performed after the raw material mixing/stirring step (step S110) has been performed, the ultrasonification step (step S120) may be performed simultaneously with the raw material mixing/stirring step (step S110).

According to the ultrasonification step, scanning can be performed in the state that the ultrasonic horn is dipped in a reaction bath filled with the mixed solution.

The ultrasonification is preformed for the purpose of activating that an oxygen atom of the titanium dioxide crystal is substituted into one of C, S, N, F, and P. As described above, when the oxygen atom of the titanium dioxide crystal is substituted into one of C, S, N, F, and P, activation is achieved under a visible light by complementing the level of a balance band.

In particular, the experiment shows that an absorption wavelength is shifted from an ultraviolet region to a visible region when impurities such as C, S, N, F, and P are doped into titanium dioxide (TiO₂).

According to the present invention, when the ultrasonification is performed with respect to the mixed solution in the reaction bath, that is, the mixed solution is bubble collapsed, the mixed solution is subject to the extreme conditions, such as the local temperature of 5000K, the local pressure of 1000 bar, and the heating/cooling ratio of 10¹⁰ K/s. For this reason, the chemical reactivity of the surface of the reactant is significantly increased, so that the doping property can be improved.

In the present step, preferably, the ultrasonification is performed by applying high-intensity ultrasound having the frequency of 15 KHz to 25 KHz and the output power of 90 W to 120 W for 1 minute to 30 minutes. When the output power of the ultrasound wave is less than 90 W, or the ultrasonification time is less than 1 minute, the doping may not be smoothly achieved. In contrast, if the output power of the ultrasound wave exceeds 120 W, or the ultrasonification time exceeds 30 minutes, a specific surface area of TiO₂ powder may be reduced. The reduction of the specific surface area is undesirable.

Filtering/Washing

In the filtering/washing step (step S130), the reactant that has been subject to the ultrasonification is filtered while washing the reactant by using washing water.

In this case, in the filtering/washing step (step S130), after the reactant that has been subject to the ultrasonification is subject to pressure-reduction filtering, the reactant is washed by using the washing water. In this case, the washing is preferably repeated at least three times. The washing solution may include distilled water.

Drying

In the drying step (step S140), the washed reactant is dried, so that the titanium dioxide doped with impurities is obtained. In this case, the washed reactant is preferably dried in a vacuum state at a temperature of about 10° C. to 70° C. for about 12 hours to about 20 hours. If the drying temperature is less than 10° C. or if the drying time is less than 12 hours, the washed reactant may not be completely dried. In contrast, if the drying temperature exceeds 70° C., or if the drying time exceeds 20 hours, there is no economical advantage.

Heat Treatment

In the heat treatment step (step S150), the doped titanium dioxide particles obtained through the drying step (Step S140) are subject to heat treatment.

In the present step, the heat treatment is preferably performed at a nitrogen gas atmosphere in which a temperature for heat treatment is in the range of about 250° C. to about 550° C. for four hours to 12 hours. In this case, for the diffusion of the nitrogen gas, carrier gas may include argon gas.

If the temperature for heat treatment is less than 250° C. or if the time for heat treatment is less than four hours, desirable crystallinity may not be obtained. In contrast, if the temperature of heat treatment exceeds 550° C. or if the time for the heat treatment exceeds 12 hours, effects are not made and only the preparing cost may be increased.

In this case, if impurities are doped into the titanium dioxide powder having the specific surface area of about 600 m²/g, the specific surface area of the titanium dioxide powder is hardly reduced. If the heat treatment is performed with respect to the titanium dioxide powder at temperature of about 200° C., the specific surface area of the titanium dioxide powder is gradually reduced to about 500 m²/g. If the heat treatment is performed with respect to the titanium dioxide powder at temperatures of about 300° C., the specific surface area of the titanium dioxide powder is reduced to about 400 m²/g. If the heat treatment is performed with respect to the titanium dioxide powder at temperatures of about 400° C., the specific surface area of the titanium dioxide powder is reduced to about 300 m²/g. In detail, the specific surface area is gradually reduced according to the increase of the temperature for the heat treatment. The reason for the heat treatment is why the doping is more completed when the heat treatment is performed in the above temperature range.

Accordingly, the impurity-doped titanium dioxide photocatalysts according to the embodiment of the present invention may be prepared.

Therefore, the titanium dioxide photocatalysts doped with impurities representing superior photo activity and photo oxidation power can be prepared in mass production at a visible light region as well as an ultraviolet region through post processes such as stirring, ultrasonification, and heat treatment in the step S110 to step S160.

Therefore, the experiment shows that the impurity-doped titanium dioxide photocatalysts prepared in the method according to the present invention represents the photocatalyst characteristic superior to an existing P25 catalyst. In addition the existing P25 photocatalysts are activated only in the ultraviolet region of 387 nm or less. In contrast, the impurity-doped titanium dioxide photocatalysts prepared in the method according to the present invention represents superior photo activity at a visible light region as well as an ultraviolet light region, so that the application field of the impurity-doped titanium dioxide photocatalysts can be remarkably increased when the impurity-doped titanium dioxide photocatalysts are applied to surroundings in which an ultraviolet (UV) lamp may not be directly used.

### Embodiments

Hereinafter, the structure and operation of the present invention will be described in detail with reference to the exemplary embodiments of the present invention. The following exemplary embodiments are illustrative purpose only and the present invention is not limited thereto.

Description about known functions and structures, which can be anticipated by those skilled in the art, will be omitted.

1. Specimen Preparation

### Embodiment 1

After mixing 10 g of titanium dioxide powder having an average diameter of about 5 nm and a specific surface area of 600 m²/g with a doping agent including 80 ml of distilled water and 20 ml of CH₃OH while stirring the mixture for 5 minutes by using a strong mechanical stirrer, the stirred doping agent was subject to ultrasonification at a frequency of about 15 Hz under the output power of about 110 W for 5 minutes. Then, the reactant was pressure-reduction filtered, and washed with distilled water.

Thereafter, after the reactant was vacuum-dried in a dry oven at a temperature of about 60° C. for 12 hours, the doped titanium dioxide was subject to heat treatment at a nitrogen atmosphere in which the temperature for the heat treatment was 400° C., thereby preparing carbon-doped titanium dioxide.

### Embodiment 2

After mixing 100 g of titanium dioxide powder having an average diameter of about 5 nm and a specific surface area of 600 m²/g with a doping agent of 5 ml of H₂O₂ and 50 ml of 2 MH₂SO₄ while stirring the mixture for 5 minutes by using a strong mechanical stirrer, the mixed solution was subject to ultrasonification at a frequency of about 20 Hz under the output power of about 120 W for 5 minutes. Then, the reactant was pressure-reduction filtered, and washed with distilled water. Thereafter, after the reactant was vacuum-dried in a dry oven at a temperature of about 60° C. for 12 hours, the doped titanium dioxide was subject to heat treatment at a nitrogen atmosphere in which the temperature for the heat treatment was 350° C., thereby preparing sulfur-doped titanium dioxide.

### Embodiment 3

After mixing 10 g of titanium dioxide powder having an average diameter of about 5 nm and a specific surface area of 600 m²/g with a doping agent containing 80 ml of distilled water, 20 ml of methyl ammonium chloride, 10 ml of isopropanol, and 15 ml of acetonitrile while stirring the mixture for 7 minutes by using a strong mechanical stirrer, the stirred doping agent was subject to ultrasonification at a frequency of about 15 Hz under the output power of about 110 W for 20 minutes. Then, the reactant was pressure-reduction filtered, and washed with distilled water.

Thereafter, after the reactant was vacuum-dried in a dry oven at a temperature of about 60° C. for 12 hours, the doped titanium dioxide was subject to heat treatment at a nitrogen atmosphere in which the temperature for the heat treatment was 400° C., thereby preparing nitrogen-doped titanium dioxide.

### Embodiment 4

After mixing 10 g of titanium dioxide powder having an average diameter of about 5 nm and a specific surface area of 600 m²/g with a doping agent containing 90 ml of distilled water, 30 ml of fluoroacetic acid, and 10 ml of acetonitrile while stirring the mixture for 10 minutes by using a strong mechanical stirrer, the stirred doping agent was subject to ultrasonification at a frequency of about 15 Hz under the output power of about 110 W for 15 minutes. Then, the reactant was subject to pressure-reduction filtered, and washed with distilled water.

Thereafter, after the reactant was vacuum-dried in a dry oven at a temperature of about 60° C. for 12 hours, the doped titanium dioxide was subject to heat treatment at a nitrogen atmosphere in which the temperature for the heat treatment was 400° C., thereby preparing fluorine-doped titanium dioxide.

### Embodiment 5

After mixing 10 g of titanium dioxide powder having an average diameter of about 5 nm and a specific surface area of 600 m²/g with a doping agent containing 10 ml of phosphoric acid, 20 ml of ethanol, and 150 ml of hydrochloric acid, while stirring the mixture for 5 minutes by using a strong mechanical stirrer, the stirred doping agent was subject to ultrasonification at a frequency of about 15 Hz under the output power of about 110 W for 5 minutes. Then, the reactant was pressure-reduction filtered, and washed with distilled water.

Thereafter, after the reactant was vacuum-dried in a dry oven at a temperature of about 60° C. for 12 hours, the doped titanium dioxide was subject to heat treatment at a nitrogen atmosphere in which the temperature for the heat treatment was 400° C., thereby preparing phosphorous-doped titanium dioxide.

### Comparative Example 1

P25 TiO₂, which has been extensively used as photocatalyst and available from Degussa Company, was prepared.

### Comparative Example 2

TiO₂ of Aldrich, which had been commercially extensively used as a photocatalyst and had a particle size of 5 nm, was prepared.

2. Estimation of Physical Property

Table 1 shows elemental analysis results measured by performing CHONS elemental analysis (Elemental analysis as Carbon, Hydrogen, Oxygen, Nitrogen, and Sulfur) with respect to specimens prepared according to embodiments 1 and 2.

TABLE 1

| Remark | Elemental Name | Element (%) | Ret. Time | Area | BC | Area ratio | k Factor |
|---|---|---|---|---|---|---|---|
| Embodiment 1 | Carbon | 2.0872 | 69 | 158532 | RS | 1.000000 | 0.450259E+07 |
| | Hydrogen | 2.3268 | 201 | 474411 | RS | 0.334166 | 0.125238E+08 |
| | Totals | 4.4141 | — | 632943 | — | — | — |
| Embodiment 2 | Carbon | 0.0000 | 69 | 3338 | RS | 1.000000 | 0.450259E+07 |
| | Hydrogen | 1.4729 | 204 | 280928 | RS | 0.011882 | 0.125238E+08 |
| | Sculpture | 4.7979 | 476 | 136529 | RS | 0.024449 | 0.186842E+07 |
| | Totals | 6.2708 | | 420795 | — | — | — |

Referring to table 1, the elemental analysis result on specimens, which are prepared according to embodiment 1, shows that the contents of carbon and hydrogen were measured as 2.0872% and 2.3268%, respectively. In addition, the elemental analysis result on specimens prepared according to embodiment 2 showed that the contents of carbon, hydrogen, and sculpture were measured as 1.4729% and 4.7979%, respectively.

Through the CHONS analysis, the doped quantity (%) of carbon or sulfur of the doped titanium dioxide photocatalysts could be analyzed.

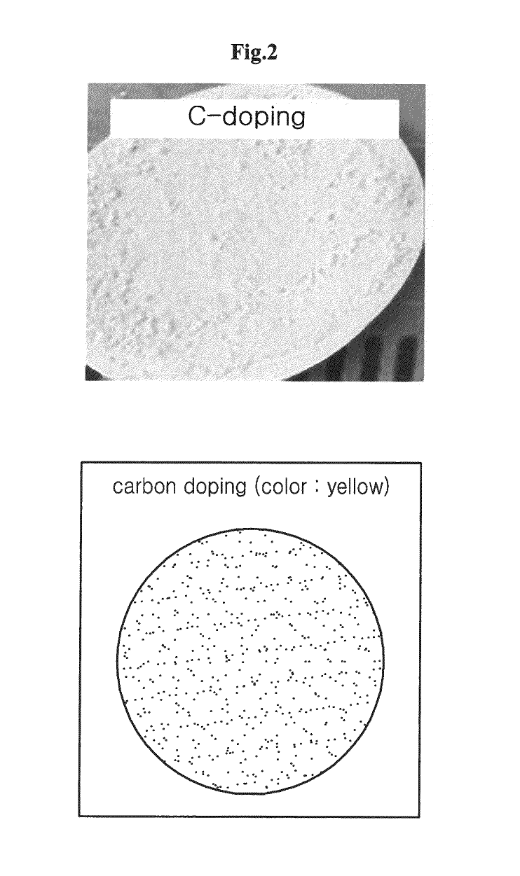

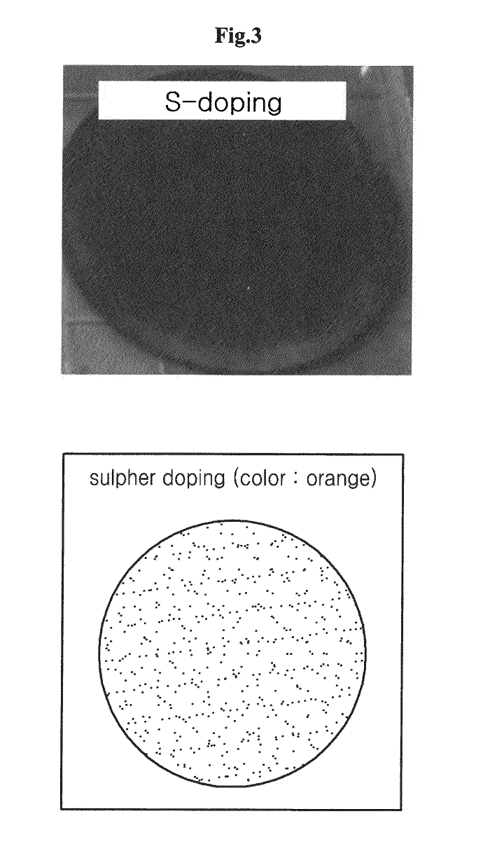

FIG. 2 is a photograph showing a specimen prepared according to embodiment 1, and FIG. 3 is a photograph showing a specimen according to embodiment 2.

Referring to FIG. 2, it could be recognized by a naked eye of an observer that, in the case of the specimen prepared according to embodiment 1, titanium dioxide was represented as a yellow color when stirring was started, and was kept in the yellow color after heat treatment had been performed. Accordingly, the surface of the titanium dioxide was doped through only stirring.

Meanwhile, referring to FIG. 3, it could be recognized by a naked eye of an observer that, in the case of the specimen prepared according to embodiment 2, the color of titanium dioxide was represented as an orange color when stirring was started, the orange color of the titanium dioxide was slightly lightened after washing had been performed, and then the color of the titanium dioxide became a light orange color.

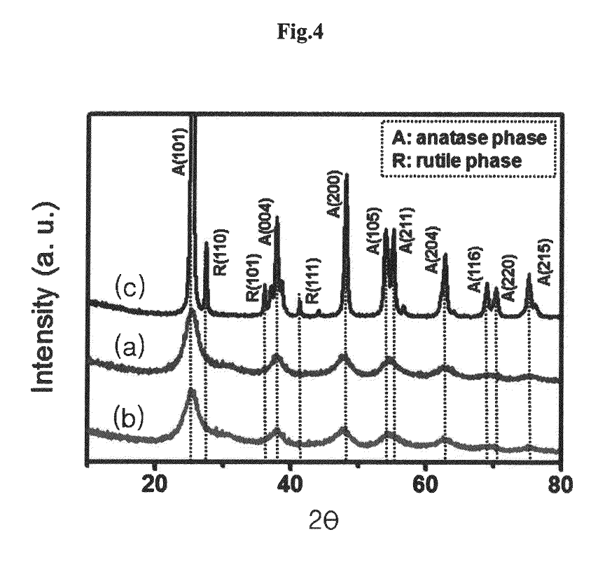

FIG. 4 is a graph showing X-ray diffraction patterns for specimens according to embodiments 1 and 2 and comparative example 1.

Referring to FIG. 4, the X-ray diffraction patterns showed that the carbon and sulfur-doped specimens (a) and (b) prepared according to embodiments 1 and 2 had a single phase crystalline of anatase and a bicrystalline phase of anatase and brookite.

In contrast, the specimen according to comparative example 1 corresponding to the photocatalyst P25 commercially used had a single crystalline phase of anatase or a bicrystalline phase of anatase and tutile.

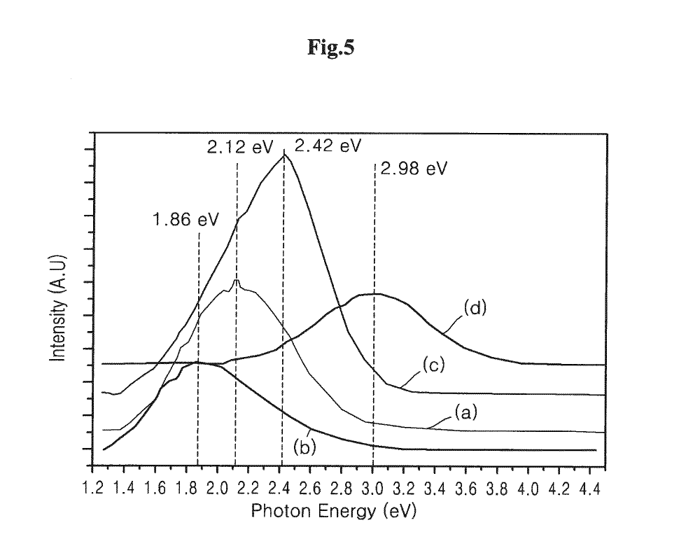

FIG. 5 is a graph showing PL (photoluminescence) measurement results for specimens according to embodiments 1 and 2 and comparative examples 1 and 2.

Referring to FIG. 5, in the case of the specimens (a) and (b) according to embodiments 1 and 2, the peak value of the photoluminescence is significantly shifted into the visible light region as compared with specimens (c) and (d) according to the comparative examples 1 and 2.

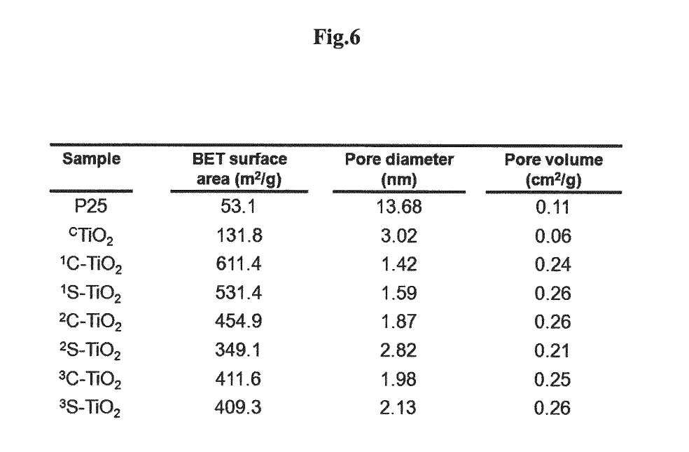

FIG. 6 is a view showing specific surface areas of specimens according to embodiments 1 and 2 and comparative examples 1 and 2.

Referring to FIG. 6, P25 and ^{c}TiO₂ corresponding to comparative examples 1 and 2 are 53.1 m²/g and 131.8 m²/g, respectively.

In contrast, carbon-doped specimens (¹C—TiO₂, ²C—TiO₂, and ³C—TiO₂) corresponding to embodiment 1 are 611.4 m²/g, 454.9 m²/g, and 411.6 m²/g, respectively.

In addition, sulfur-doped specimens (¹S—TiO₂, ²S—TiO₂, and ³S—TiO₂) corresponding to embodiment 2 are 611.4 m²/g, 454.9 m²/g, and 411.6 m²/g, respectively.

As recognized from the experimental results, carbon or sulfur-doped specimens according to embodiments 1 and 2 represent specific surface areas superior to specimens according to comparative examples 1 and 2.

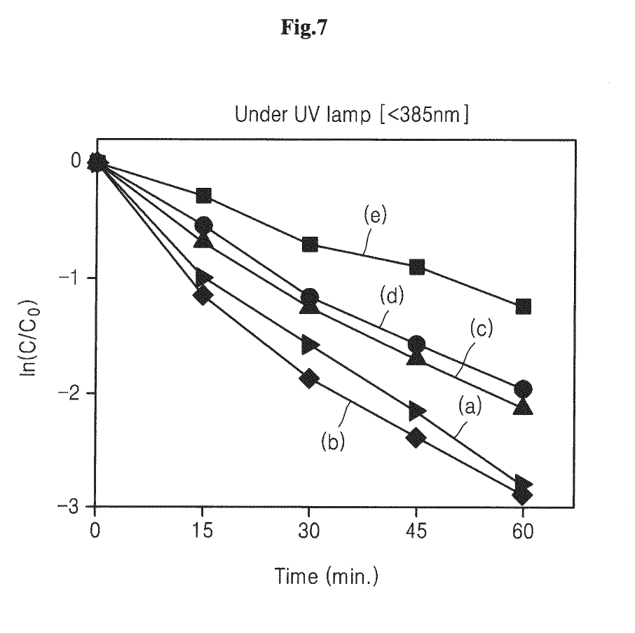

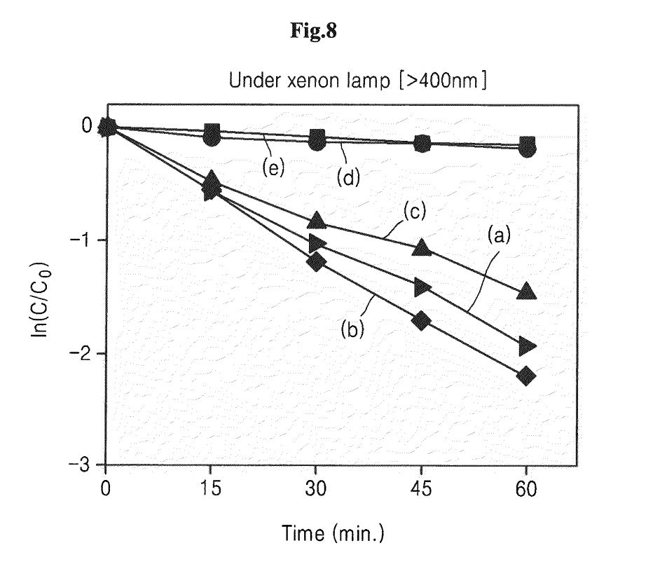

FIGS. 7 and 8 are graphs showing organic matter photo-oxidation experimental results related to specimens according to embodiments 1 to 3 and comparative examples 1 and 2. In this case, FIG. 7 shows a photo-oxidation experimental result through Reactive black 5, and FIG. 8 shows a photo-oxidation experimental result through Rhodamine B.

In this case, according to the organic matter photo-oxidation experiments, the specimens prepared according to embodiments 1 to 3 and comparative examples 1 and 2 are stored in a sealed test tube together with 1 mg/L of Reactive Black 5 and B 0.1 g/L of Rhodamine B for 40 hours.

Referring to FIGS. 7 and 8, according to the organic matter photo-oxidation experimental results, the specimens (a), (b), and (c) prepared according to embodiments 1 to 3 have superior purification abilities at both a visible light region and an ultraviolet light region as compared with that of specimens (d) and (e) prepared according to comparative examples 1 and 2. In this case, the specimens (a), (b), and (c) prepared according to embodiments 1 to 3 represent purification ability superior to the specimens (d) and (e) prepared according to the comparative examples 1 and 2 because the bandgap energy of the specimens (a), (b), and (c) prepared according to embodiments 1 to 3 is lowered due to carbon, sulfur, and nitrogen doping. Accordingly, the specimens prepared according to embodiments 1 to 3 represent photocatalysts superior to specimens prepared according comparative examples 1 and 2 in the visible light region.

When the titanium dioxide powder is doped with C, S, and P, the level of the valance band is completed, so that the photo activity and the photo oxidation power are improved.

In particular, the sulfur-doped specimens (b) prepared according to the embodiment 2 represents the photo oxidation power superior to carbon and phosphorous-doped specimens (a) and (c) prepared according to embodiments 1 and 3.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for preparing impurity-doped titanium dioxide photocatalysts, the method comprising:
(a) stirring titanium dioxide powder while mixing the titanium dioxide powder with a doping agent;
(b) performing ultrasonification with respect to a mixed solution;
(c) washing a reactant obtained through the ultrasonification by using a washing solution while performing filtering for the reactant under reduced pressure;
(d) obtaining doped titanium dioxide particles by drying the reactant; and
(e) performing heat treatment with respect to the doped titanium dioxide particles at a nitrogen atmosphere.

2. The method of claim 1, wherein the doping agent includes at least one selected from the group consisting of distilled water (H₂O), methanol (CH₃OH), sulfuric acid (H₂SO₄), hydrogen peroxide (H₂O₂), methyl ammonium chloride, isopropanol, acetonitrile, fluoroacetic acid, phosphoric acid, ethanol, and hydrochloric acid.

3. The method of claim 2, wherein the doping agent is a mixed solution of the distilled water (H₂O) and the methanol (CH₃OH), and a volume ratio of the distilled water (H₂O) to the methanol (CH₃OH) is 3:1 to 5:1.

4. The method of claim 2, wherein the doping agent is a mixed solution of 2M sulfuric acid (H₂SO₄) and the hydrogen peroxide (H₂O₂), and a volume ratio of the sulfuric acid (H₂SO₄) to the hydrogen peroxide (H₂O₂) is 8:1 to 12:1.

5. The method of claim 1, wherein the washing solution is distilled water.

6. The method of claim 1, wherein, in step (b), the ultrasonification is performed for 1 minute to 30 minutes under output power of 90 W to 120 W.

7. The method of claim 1, wherein, in step (e), the heat treatment is performed for 4 hours to 12 hours at a temperature of 250° C. to 550° C.
